(19) United States
(12) Patent Application Publication
(10) Pub. No.: US 2015/0059936 A1
(43) Pub. Date: Mar. 5, 2015

(54) COMPACT POCKET ORGANIZER

(71) Applicant: Left Field Design, LLC, Menlo Park, CA (US)

(72) Inventor: RICHARD W. SINGER, MENLO PARK, CA (US)

(73) Assignee: Left Field Design, LLC, Menlo Park, CA (US)

(21) Appl. No.: 14/014,086

(22) Filed: Aug. 29, 2013

(51) Int. Cl. A45C 1/06; B42F 1/02

(52) U.S. Cl. CPC A45C 1/06; B42F 1/02; A45C 2001/062
USPC 150/138; 442/131; 24/67.3; 24/67.9

(57) ABSTRACT

Small form-factor apparatus and methods for holding, securing, and accessing personal items normally carried on a keychain or in a wallet including, for example, keys, universal serial bus (USB) drive, driver license, credit cards, radio-frequency identification (RFID) cards and paper currency are disclosed. Clips, organizers, combination clip and organizers, and radio frequency blocking cards are disclosed that have a substantially planar profile.

### FIELD

The present disclosure relates to small form-factor apparatus and methods for holding, securing, and accessing personal items normally carried on a keychain or in a wallet including, for example, keys, universal serial bus (USB) drive, driver license, credit cards, radio-frequency identification (RFID) cards and paper currency.

### BACKGROUND

Conventional wallets and key holders are inherently bulky and, when worn in pants pockets, cause pocket-bulge that is both uncomfortable and unsightly. Wallets that are obvious where worn also increase vulnerability to pickpockets. Key rings and key chains are particularly uncomfortable because keys naturally splay in a pants pocket, causing key serrations and pointed tips to poke anatomy. Key organizers, in pocketknife embodiments, cannot be open with a single hand. Money clips, because they are small and have a small moment-arm, yield easily and then no longer securely hold one or several paper bills. Because credit cards and identification cannot be retained by a money-clip, these cards are easily dislodged. The clips on combination card holders and money clips tend to be either short leaf springs or hinged magnets, which do not yield easily and do not provide secure grip with more than a few bills. Unloaded card holders with segmented compartments are inherently thick because of the material stack-up. Single-compartment card holders without an elastic member do not securely hold only a few cards. Card holders with an elastic member compromise easy card access and the elastic relaxes over time, compromising card retention. Card holders and wallets made from stitched leather or fabric wear out, over time, from worn stitching. RFID credit cards can be non-invasively read with a portable scanner, through non-shielded wallets and clothing. With over two hundred million RFID cards in circulation, unauthorized RFID scanning is a common cause of identification theft.

### SUMMARY

Combination clips and organizers and organizers provided by the present disclosure describe a resilient spring-clip to retain items such as credit cards and also to contain devices such as keys as part of a thin laminate with devices held between the outside of the spring-clip and a cover plate. In certain embodiments, the spring-clip and the organizer are not combined, so that they are independent in both form and function, minimizing the thickness of each, and the organizer holds keys between two plates of the same length and width. The term clip refers to a modified money-clip intended to retain and hold inserts such as credit cards, cash, and/or identification cards. The term combination clip and organizer refers to a combined clip and organizer

A radio frequency (RF) blocking card provided by the present disclosure includes a compact shield for blocking unauthorized scanning of RFID cards. An RF blocking apparatus can be used in combination with a clip or combination clip and organizer provided by the present disclosure or with conventional wallets or card holders.

In a first aspect, clips are disclosed comprising a plate having a first surface, a second surface, and a first edge; and a retaining clip extending from the first edge and folded onto the first surface and a clip end.

In a second aspect, organizers are disclosed comprising a backing plate, wherein the backing plate comprises one or more internally-threaded bosses peripherally arranged toward sides the backing plate, and configured to rotatably mount devices; and a cover plate, wherein the cover plate comprises one or more device access slots.

In a third aspect, combination clip and organizers are disclosed comprising a first plate having a first surface, a second surface, and a first edge; a retaining clip extending from the first edge and folded onto the first surface and a clip end; and a second plate, wherein the second plate overlies the second surface of the first plate; and one or more internally-threaded bosses peripherally arranged toward outer edges of the first plate, and configured to rotatably mount devices

In a fourth aspect, RF blocking apparatus for shielding inserts from radio frequency radiation are disclosed comprising a first plate; and a second plate overlying the first plate, wherein the first plate and the second plate comprise a metallized fabric.

### BRIEF DESCRIPTION OF THE DRAWINGS

FIG. 1 shows a perspective view of a card clip in accordance with certain embodiments of this disclosure.

FIG. 2 shows a perspective view of a clip holding an electrically conductive removable card in accordance with certain embodiments of this disclosure.

FIG. 3 shows a perspective view of an organizer in accordance with certain embodiments of this disclosure.

FIG. 4 shows a cross-sectional view taken along section 4-4 of FIG. 3, showing an organizer hardware assembly, in accordance with certain embodiments of this disclosure.

FIG. 5 shows an exploded assembly view of the FIG. 3 organizer in accordance with certain embodiments of this disclosure.

FIG. 6 shows a perspective view of a combination clip and organizer in accordance with certain embodiments of this disclosure.

FIG. 7 shows a cross-sectional view taken along section 7-7 of FIG. 6, showing a combination clip and organizer hardware assembly, in accordance with certain embodiments of this disclosure.

FIG. 8 shows a perspective view of a combination clip and organizer holding an electrically conductive removable card in accordance with certain embodiments of this disclosure.

FIG. 9 shows an exploded assembly view of the FIG. 6 combination clip and organizer in accordance with certain embodiments of this disclosure.

FIG. 10 shows an exploded assembly view of an RF-blocking shield in accordance with certain embodiments of this disclosure.

FIG. 11 shows an exploded assembly view of RFID cards placed between two RF blocking shields in accordance with certain embodiments of this disclosure.

Reference is now made to certain embodiments of clips, organizers, combination clips and organizers, and RF blocking cards. The disclosed embodiments are not intended to be limiting of the claims. To the contrary, the claims are intended to cover all alternatives, modifications, and equivalents.

### DETAILED DESCRIPTION

### Clip

The clip comprises a three-sided housing that grips and retains inserts such as credit-cards, folded paper currency, identification, and business cards. In a particular embodiment, the profile of the card clip is a tear drop shape, with the two long sides in contact at their ends, and with at least one of the ends flared to receive and grip cards, currency and identification. One of the long sides has a trapezoidal opening, effecting two long, tapered beams on either side of the opening, and a void between the tapered beams so that cards and cash are visible, accessible and readily available. The length of the beam, combined with a root width that is twice as wide as the tip, increases leaf-spring elasticity and fatigue resistance. The width of the opening between the tapered beams controls spring resistance, and also permits a thumb or finger to push cards outwards from the clip, with cards still held by the clip, allowing the user to easily select, remove and insert a single card or cash. The side opposite from the tapered beams is an unrelieved and smooth surface to prevent magnetic tape abrasion on cards that include magnetic tape.

In certain embodiments, the clip is fabricated from composite material and/or metal that, unlike leather or fabric wallets and card-holders, does not include stitching that is vulnerable to wear; and when used with the RF blocking card described herein, blocks RFID cards from unauthorized scanning

### Organizer

An organizer provided by the present disclosure comprises a rigid backing plate with threaded bosses that are peripherally arranged for key-mounting; a protrusion, or protrusions in the middle of the backing plate for limiting rotational travel of the keys; washers provided as spacers when keys are not installed; a cover-plate assembly consisting of a rigid plate with slots over the keys for key access, countersunk holes, and thin wear-washers adhered to the side of the cover plate opposite the countersinks and concentric to the holes; and flathead screws which fasten the cover-plate assembly to the backing plate and captivate washers, keys, and/or tools such a flash-memory drive or LED flashlight. Cover plate access slots can be sized for the thumb, so that keys can be rotated open or closed with one hand.

In an embodiment, the backing plate material is 1 mm thick stainless steel with press-fit, internally-threaded standoffs and the cover plate material is 1.5 millimeter thick aluminum so that the key organizer can be durable, rigid, thin and unobtrusive when in a pants pocket. Both the backing plate and cover plate have a corner radius of at least 3 millimeters on each corner and deburred edges for comfortable wear and handling. This embodiment has a backing plate and a cover plate that are the same length and width as a credit card for compactness and dimensional compatibility with most non-vehicle keys available in North America, but the width and length could increase to fit with larger keys that are more common in Asia and in Europe.

In certain embodiments the height of the internally threaded, backing plate standoffs are less than the thickness of one standard key thickness (2 mm), or less than the aggregate of multiple key thickness, so that the keys can be held in compression with cover plate and screws installed, and so that rotational key resistance can be adjusted by varying screw torque.

An embodiment has three backing plate key positions: two positions having keys inset from the long sides, with adjacent key heads just inset from a short side; and a third position having a key or keys inset from the short side and the key head or key heads inset from one of the long sides. Since all keys are contained within the backing plate and cover, nothing sharp or pointed protrudes from the key organizer envelope. Internally threaded backing plate standoffs may be metric because off-shelf metric standoffs are available in 2 mm height increments that match increases in height when keys are stacked on top of each other, providing the same clearances with the cover plate when one or more keys are stacked. In this arrangement, backing plates can be assembled with standoff heights that support key quantities in multiples of three, for example, three-key backing plates or six-key backing plates. Since backing plates support key quantities in multiples of greater than two, the thickness of the modified product is minimized.

In another embodiment, a removable key ring is provided to replace a backing plate washer or key and to provide an attachment mechanism for oversized keys such as vehicle keys that are, or include, wireless electronic devices.

In certain embodiments, flathead screws are specified so that, taken together with the backing plate's press-fit standoffs, all hardware is flush or below flush to prevent dermal abrasion or abrasion of anything in contact with the key organizer In certain embodiments, a nylon patch is specified at the tip of the screw to prevent screws from loosening.

### Combination Clip and Organizer

A combination clip and organizer provided by the present disclosure is the same as the fore-mentioned organizer, except that the backing plate of the organizer is replaced with the fore-mentioned card clip housing, modified to include press-fit, internally threaded standoffs installed in the unrelieved side of the housing that is opposite from the windowed side and with the standoff protrusions on the outside of the housing. Advantages of this construction include a common blacking plate for keys and cards, common tooling for the card clip and combination wallet described herein, as well as a common cover plate shared by the key organizer and the combination wallet. Henceforth, the modified card clip housing will be referred to as the combination backing plate.

In certain embodiments, the heights of the internally threaded, combination backing plate standoffs are less than the thickness of one standard key thickness (2 mm), or less than the aggregate of multiple key thicknesses, so that the keys can be held in compression with cover plate and screws installed, and so that rotational key resistance can be adjusted by varying screw torque.

An embodiment has three combination backing plate key positions: two positions having keys inset from the long sides, with adjacent key heads just inset from a short side; and a third position having a key or keys inset from the short side and the key head or key heads inset from one of the long sides. Because all keys are contained within the cover and combination backing plate, nothing sharp or pointed protrudes from the combination wallet envelope. Internally threaded combination backing plate standoffs may be metric because off-shelf metric standoffs are available in 2 mm height increments that match increases in height when keys are stacked on top of each other, providing the same clearances with the cover plate when one or more keys are stacked. In this arrangement, combination backing plates can be assembled with standoff heights that support key quantities in multiples of three, for example, a three-key combination backing plates or a six-key combination backing plate. Because combination backing plates support key quantities in multiples of greater than two, the thickness of the combination product is minimized.

In certain embodiments, flathead screws are specified so that screw heads are flush or below flush to prevent dermal-abrasion or abrasion of anything in contact with the combination clip and organizer A nylon patch is specified at the tip of the screw to prevent screws from loosening. Combination backing plate standoffs are flush-mounted to prevent magnetic tape abrasion when cards with magnetic strips are inserted or removed from the combination clip and organizer

The clip component, of the combination clip and organizer, is the combination backing plate, and comprises a three-sided housing that grips and envelops credit-cards, folded paper currency, identification, and business cards. In a particular embodiment, the profile of the card clip component is a tear drop shape, with the two long sides in contact at their ends, and with at least one of the ends flared to receive and grip cards, currency and identification. One of the long sides has a trapezoidal opening, effecting two long, tapered beams on either side of the opening, and a void between the tapered beams so that cards and cash are visible, accessible and readily available. The length of the beam, combined with a root width that is twice as wide as the tip, increases leaf-spring elasticity and fatigue resistance. The width of the opening between the tapered beams controls spring resistance, and also provides card access so a thumb or finger can push cards outwards from the clip, with cards still held by the clip, allowing the user to easily select, remove and insert a single card or cash. The side opposite the tapered beams is an unrelieved and smooth surface, with flush mounted standoffs installed flush or below flush, to prevent magnetic tape abrasion on cards that include magnetic tape.

In certain embodiments, the combination clip and organizer is fabricated from composite material and/or metal that, unlike leather or fabric wallets and card-holders does not include stitching that is vulnerable to wear; and when used with the RF blocking card described herein, blocks unauthorized scanning of RFID cards.

### RF Blocking Card

A RF blocking card provided by the present disclosure is a thin, credit card sized, composite, with a layer of conductive material such as metalized fabric. In certain embodiments, an RF blocking card can be held within a clip to block unauthorized scanning of RFID cards contained between the RF blocking card and the unrelieved side of the card clip.

A RF blocking card can be fabricated from a material that is softer than the card clip and non-abrasive, so it cannot abrade the card clip, or combination clip and organizer backing plate, which might then abrade magnetic tape when cards are inserted or removed.

In certain embodiments, two RF blocking cards are used to sandwich RFID cards within a non-RF blocking wallet, or card holder, to block unauthorized RF scanning of, for example, RFID cards.

Other features of the present disclosure will become apparent from the following detailed description.

### Example Embodiments

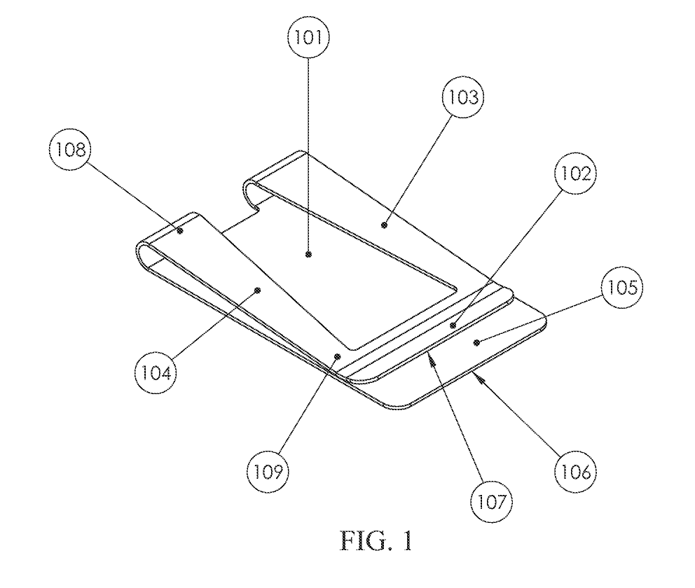

The FIG. 1 clip is shown empty and in a pre-loaded condition, but can hold multiple cards and cash between the flat side 101, that is at least the width and length of a credit card for enveloping such cards, and the flared bridge 102 that joins two stiff, tapered leaf springs 103 and 104. The side of card clip disclosed herein that comprises leaf springs 103 and 104 is as long as possible, to maximize leaf spring elasticity and fatigue resistance, and still provide for an adequate land 105, between the end of the flared bridge 102 and the non-hemmed end of the card clip 106, for inserting a card or cards at an acute angle into the flared opening 107 of the clip. A spring force equal to or greater than 7 pounds is preferred for securely holding cards, but such force makes opening the card clip with fingernails moderately difficult, so the fore-mentioned method of inserting a card or cards into the card clip provides a practical mechanical advantage. Leaf springs 103 and 104 can be tapered, for uniform stress distribution and maximum elasticity, with, for example, a root width 108 that is twice that of the tip width 109.

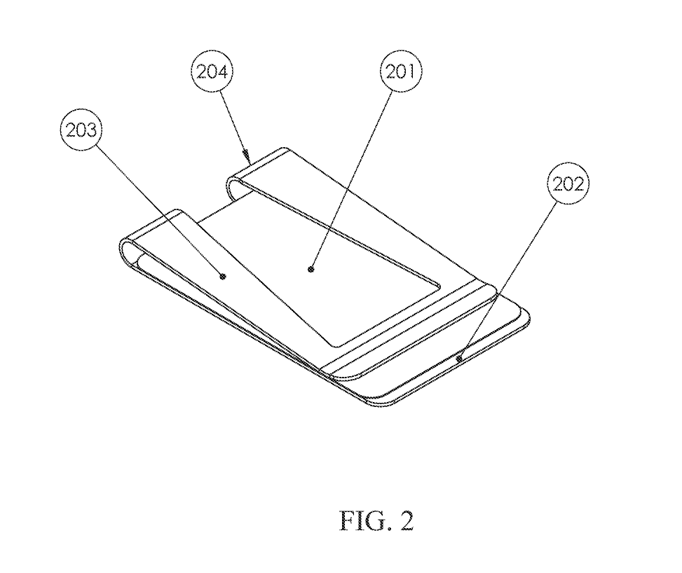

The FIG. 2 clip is shown holding a single card 201 that may be an electrically-conductive shield for blocking radio frequencies of RFID cards, which may be sandwiched between card 201 and the flat side 202 of the card clip. The card clip is a three-sided housing having: a windowed side 203 for accessing a card 201, or multiple cards and paper currency; an unrelieved, flat side 202; and a hemmed side 204, which in certain embodiments may be replaced with a short, flat side, having 2 folds.

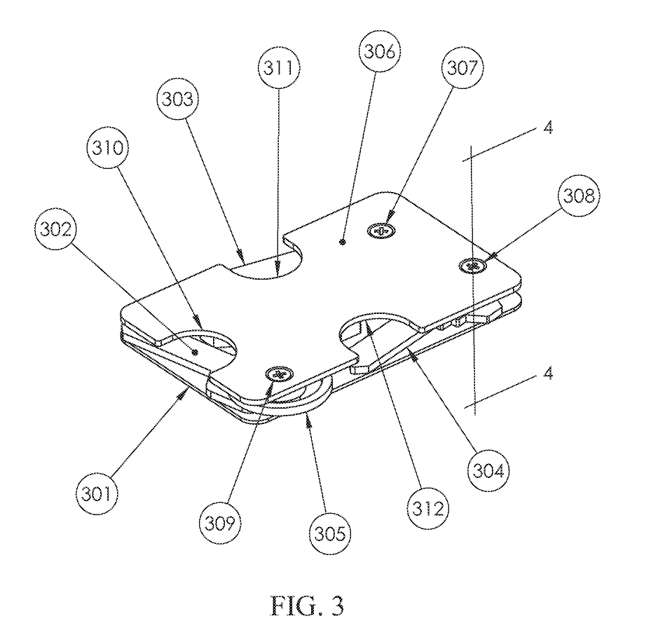

FIG. 3 shows an organizer with a backing plate 301 that holds keys 302, 303 and 304, or multiple keys, spacers (not shown), and a key ring 305 with two stacked layers of three items. Keys 302, 303 and 304 are shown in the retracted, or closed position, and the cover 306, key ring 305 and spacer, or spacers (not shown), are held in place by flathead screws 307, 308 and 309. Cover 306 key-access slots 310, 311 and 312 are located above the retracted keys 302, 303 and 304 and are sized and positioned so keys, which pivot around screws 307, 308 and 309, can be rotated open or closed single-handedly with a thumb or index finger. The cover 306 is held in place by more than one screw, so it cannot rotate and loosen screws 307, 308 and 309 when keys or tools, such as a USB flash drive, are rotated in and out of the organizer

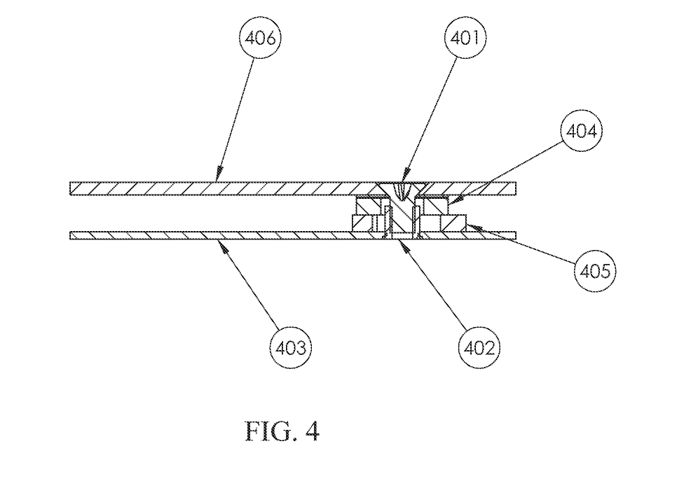

FIG. 4 shows the laminated construction of the key organizer embodiment shown in FIG. 3. One of the three identical sets of hardware is shown, including flathead screw 401 and internally threaded backing plate standoff 402, which is press-fit into, and flush-mounted to, 0.9 millimeter thick backing plate 403. Off-shelf, internally-threaded M3 standoffs are available in 2 millimeter height increments, which match the thickness of a standard key, so metric M3 standoffs for thin sheet metal installation can be specified at heights of 2 millimeters, 4 millimeters and 6 millimeters to match stacked key thicknesses of one, two or three keys, and when installed in 0.9 millimeter-thick backing plate 403, the top of the specified standoff, illustrated by standoff 402, will always have 0.9 millimeters of clearance with cover 406. Spacer 404 and key 405 are held in compression between backing plate 403 and cover 406 by lightly-tightened screw 401. Although spacer 404 and key 405 are shown for purposes of illustration, two keys, or two spacers, or a tool such as a USB flash drive with a height approximately equal to 4 millimeters could also be used. Another advantage of the construction shown in this embodiment is that off-shelf M3 metric screws with sufficient thread engagement can be used with off-shelf M3 metric standoffs, to minimize hardware costs. Key case materials used in this embodiment include: nylon-patch screws, illustrated by screw 401, to resist loosening; 0.9 millimeter-thick stainless steel, in backing plate 403, for strength and a minimum cross-sectional thickness to install recessed standoffs; 1.5 millimeter-thick 6061-T6 aluminum, in cover plate 406, for a rigid plate with sufficient thickness to recess M3 flathead screw heads, illustrated by screw 401, while minimizing weight.

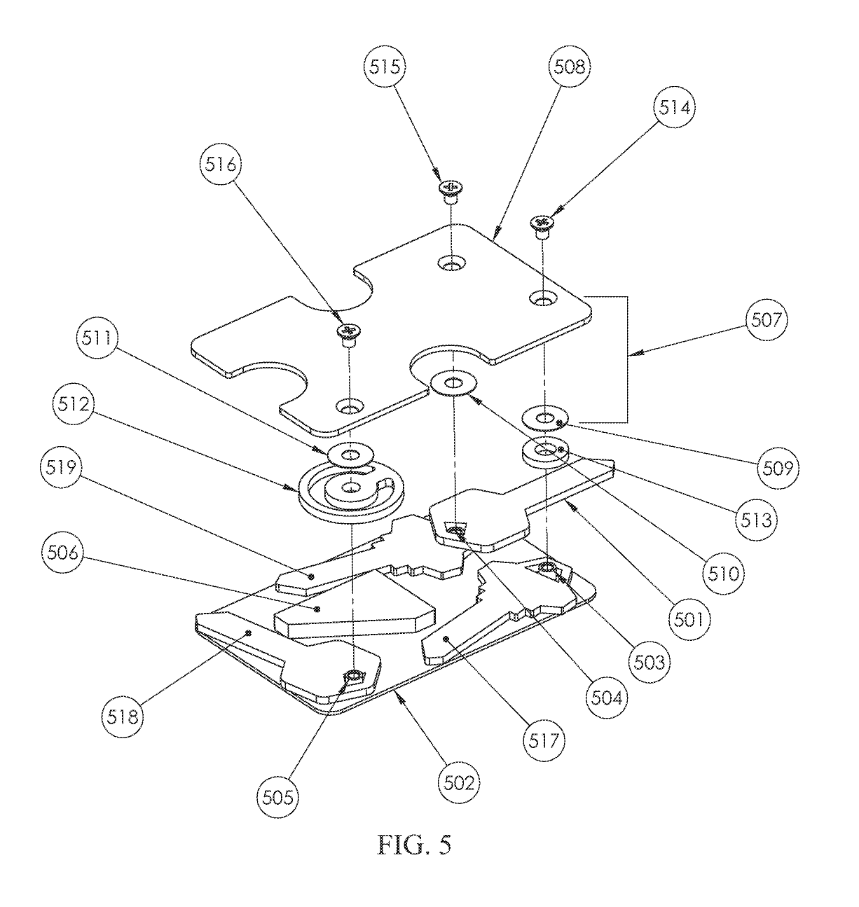

With reference to FIG. 3, FIG. 5 shows an exploded assembly-view of the FIG. 3 key organizer, with a fourth key 501 shown rotated 180 degrees in an open position. In this embodiment, backing plate 502 is a sub-assembly that includes internally-threaded, press-fit standoffs 503, 504 and 505, and key over-travel limit 506, that is permanently adhered to backing plate 502, and sized accordingly so that the height is less than the specified standoff height. The cover plate assembly 507 consists of cover plate 508 and wear-resistant, thin-plastic washers 509, 510 and 511, which are permanently adhered to cover plate 508, to reduce friction and wear when keys, spacers, and/or tools are rotated in and out of the key case. Removable key ring 512 is interchangeable with spacer 513, at the standoff position occupied by spacer 513. Spacer 513, or multiple, identical spacers, is used to fill the void or voids when the key organizer is not occupied or is partially occupied by keys and/or tools. Nylon-patch, flathead screws 514, 515 and 516: fasten cover assembly 507 to backing plate threaded standoffs 503, 504 and 505; hold keys 501, 517, 518 and 519 between cover-plate assembly 507 and backing plate 502; and provide a resistance fit when keys 501, 517, 518 and 519 are rotated around standoffs 503, 504 and 505.

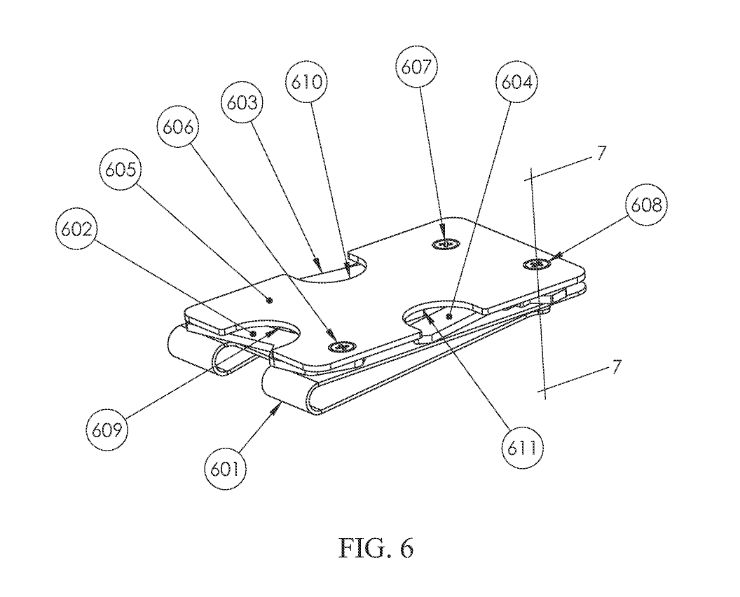

FIG. 6 shows the combination clip and organizer, with a combination backing plate 601 that holds keys 602, 603 and 604, or three spacers (not shown), or a combination of spacers and keys. Keys 602, 603 and 604 are shown in the retracted, or closed position, and the cover 605, keys and/or spacers (not shown), are held in place by flathead screws 606, 607 and 608. Cover 605 key-access slots 609, 610 and 611 are located above the retracted keys 602, 603 and 604 and are sized and positioned so keys, which pivot around screws 606, 607 and 608, can be rotated open or closed single-handedly with a thumb or index finger. The cover 605 is held in place by more than one screw, so it cannot rotate and loosen screws 606, 607 and 608 when keys or tools, such as a USB flash drive, are rotated in and out of the combination clip and organizer

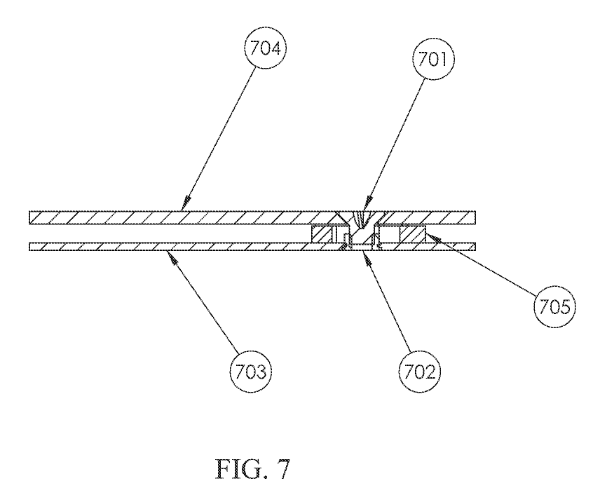

FIG. 7 shows the laminated construction of the combination clip and organizer embodiment shown in FIG. 6. One of the three identical sets of hardware is shown, including flathead screw 701 and internally threaded backing plate standoff 702, which is press-fit into, and flush-mounted to, 0.9 millimeter thick combination backing plate 703. Off-shelf, internally-threaded M3 standoffs are available in 2 millimeter height increments, which match the thickness of a standard key, so metric M3 standoffs for thin sheet metal installation can be specified at heights of 2 millimeters, 4 millimeters and 6 millimeters to match stacked key thicknesses of one, two or three keys, and when installed in 0.9 millimeter-thick backing plate 703, the top of the specified standoff, illustrated by standoff 702, will always have 0.9 millimeters of clearance with cover 704. Key 705 is held in compression between backing plate 703 and cover 704 by lightly-tightened screw 701. Although a single key 705 is shown for purposes of illustration, two stacked keys, or two spacers, or a tool such as a USB flash drive with a height approximately equal to 4 millimeters could also be used in a combination backing plate with 4 millimeter-high standoffs. Another advantage of the construction shown in this embodiment is that off-shelf M3 metric screws with sufficient thread engagement can be used with off-shelf M3 metric standoffs, to minimize hardware costs. Combination clip and organizer materials used in this embodiment include: nylon-patch screws, illustrated by screw 701, to resist loosening; 0.9 millimeter-thick, half-hard, 301 stainless steel, in combination backing plate 703, for strength, elasticity, and a minimum cross-sectional thickness to install recessed standoffs; 1.5 millimeter-thick 6061-T6 aluminum, in cover plate 704, for a rigid plate with sufficient thickness to recess M3 flathead screw heads, illustrated by screw 701, while minimizing weight.

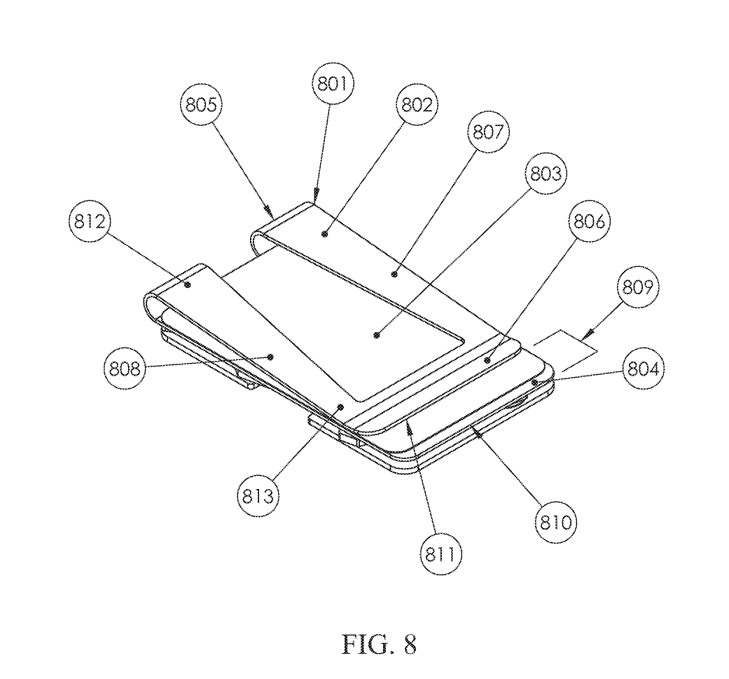

FIG. 8 shows the combination clip and organizer, of the present disclosure, with a modified backing plate 801 having: a windowed side 802 for accessing a card 803, or multiple cards and paper currency; an unrelieved, flat side 804; and a hemmed side 805, which could alternatively replace the hem with a short, flat side, having 2 folds. The modified backing plate 801 is shown holding a single card 803 in a pre-loaded condition, but it can hold multiple cards and cash between the flat side 804, that is at least the width and length of a credit card for enveloping such cards, and the flared bridge 806 that joins two stiff, tapered leaf springs 807 and 808. The side of the modified backing plate 801 that comprises leaf springs 807 and 808 is as long as possible, to maximize leaf spring elasticity and fatigue resistance, and still provide for an adequate land 809, between the end of the flared bridge 806 and the non-hemmed end 810 of modified backing plate 801, for inserting a card or cards at an acute angle into the flared opening 811. A spring force equal to or greater than 7 pounds is preferred for securely holding cards, but such force makes opening the card clip with fingernails moderately difficult, so the fore-mentioned method of inserting a card or cards into the card clip provides a practical mechanical advantage. Leaf springs 807 and 808 are tapered, for uniform stress distribution and maximum elasticity, with a root width 812 that is twice that of the tip width 813. The card 803 shown in the present embodiment is an electrically-conductive shield for blocking radio frequencies of RFID cards which may be sandwiched between card 803 and the flat side 804 of modified backing plate 801.

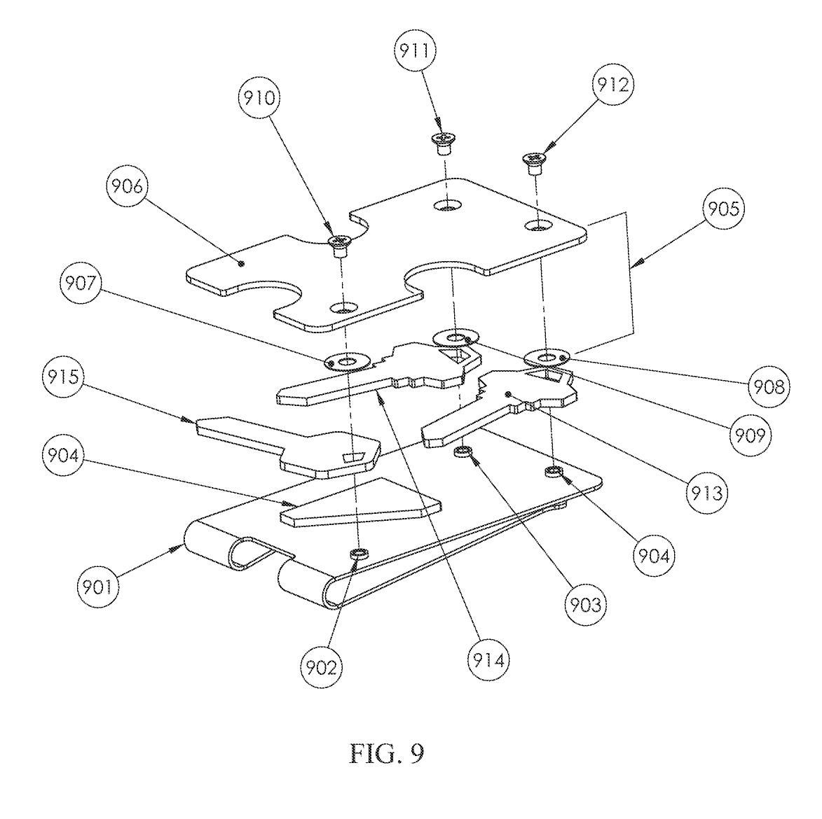

With reference to FIG. 6, FIG. 9 shows an exploded assembly-view of the FIG. 6 combination clip and organizer In this embodiment, backing plate 901 is a sub-assembly that includes internally-threaded, press-fit standoffs 902, 903 and 904, and key over-travel limit 904, that is permanently adhered to backing plate 901, and sized accordingly so that the height is less than the specified standoff height. The cover-plate assembly 905 consists of cover plate 906 and wear-resistant, thin-plastic washers 907, 908 and 909, which are permanently adhered to cover plate 906, and reduce friction and wear when keys, spacers, and/or tools are rotated in and out of the combination clip and organizer. Spacer 513 (FIG. 5), or multiple, identical spacers, is used to fill the void or voids when the combination clip and organizer is not occupied or is partially occupied by keys and/or tools. Nylon-patch, flathead screws 910, 911 and 912: fasten cover assembly 905 to backing plate threaded standoffs 902, 903 and 904; hold keys 913, 914 and 915 between cover-plate assembly 905 and backing plate 901; and provide a resistance fit when keys 913, 914 and 915 are rotated around standoffs 902, 903 and 904.

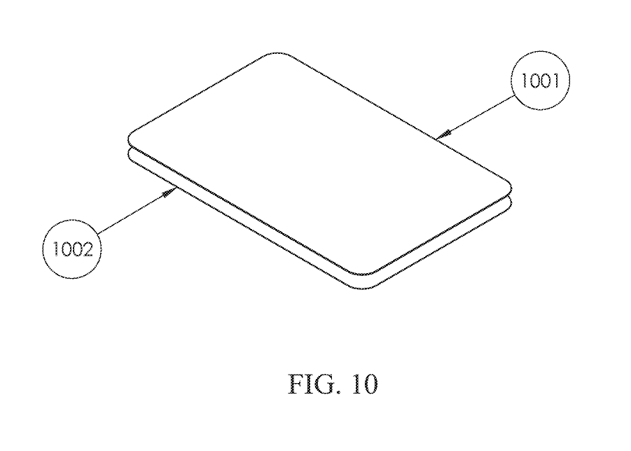

FIG. 10 shows an exploded assembly view of the RF blocking card described by the present disclosure. In this embodiment, the RF blocking card is fabricated from 0.5 millimeter thick composite panel 1001, comprising carbon-fiber and/or fiberglass woven fabric and an epoxy or polyester resin, including or laminated to, metalized fabric 1002, such as copper-coated polyester taffeta. Advantages of the construction include: stiffness; flexibility; rip resistance; crease resistance; durability; light weight; an effective radio frequency blocking shield on one side and a highly cosmetic surface on the other side; and an overall shield thickness that is half the thickness of a credit card.

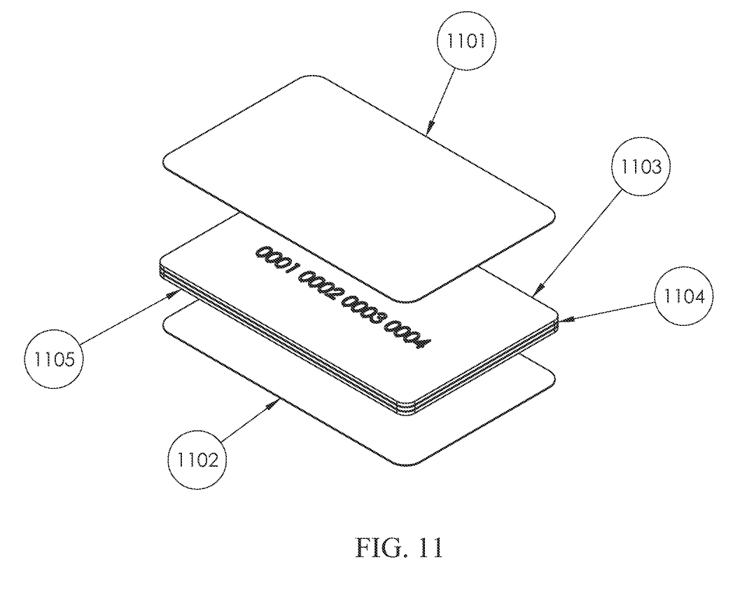

The FIG. 11 exploded assembly view shows two of the RF blocking card described by FIGS. 10, 1101 and 1102, and three RFID cards 1103, 1104, and 1105. Although three RF cards are shown in this illustration, a single card or a different multiple of cards could also be placed between RF blocking cards 1101 and 1102, and in a fabric or leather wallet or card holder, to block unauthorized RF scanning of RFID cards. The combined thickness of RF blocking cards 1101 and 1102 is equal to one embossed credit card, so the shield adds minimal thickness to a conventional wallet or card holder and, unlike an RF blocking sleeve, does not compromise card access.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

What is claimed is:

1. A clip, comprising:
a plate having a first surface, a second surface, and a first edge; and
a retaining clip extending from the first edge and folded onto the first surface and a clip end.

2. The clip of claim 1, wherein the plate and the retaining clip are formed from a single piece.

3. The clip of claim 1, wherein the retaining clip comprises a first leaf spring and a second leaf spring, wherein the first leaf spring and the second leaf spring are connected at the end.

4. The clip of claim 1, wherein the retaining clip is configured to provide a compressive force against the first surface.

5. The clip of claim 1, wherein the retaining clip is configured to retain inserts against the first surface.

6. The clip of claim 1, wherein the retaining clip comprises a flared end, wherein the flare is away from the first surface.

7. The clip of claim 1, wherein the flared end is configured to slidably receive inserts.

8. The clip of claim 1, wherein each of the first leaf spring and the second leaf spring are characterized by a beam length with a root width that is twice as wide as the tip.

9. The clip of claim 1, wherein the first surface comprises a land.

10. The clip of claim 1, wherein he land is configured to receive inserts by directing the inserts at an acute angle with respect to the first surface.

11. The clip of claim 1, wherein the base and the retaining clip comprise a material selected from an electrically conductive material, a radio frequency shielding material, an elastic material, and a combination of any of the foregoing.

12. The clip of claim 1, comprising a removable plate configured to provide RF shielding.

13. An organizer, comprising:
a backing plate, wherein the backing plate comprises one or more internally-threaded bosses peripherally arranged toward sides the backing plate, and configured to rotatably mount devices; and
a cover plate, wherein the cover plate comprises one or more device access slots.

14. The clip of claim 13, wherein the devices are selected from keys, tools, and combinations thereof.

15. The clip of claim 13, wherein the device access slots are configured to at least partially expose the devices.

16. The clip of claim 13, wherein the devices are rotatable using a finger.

17. The organizer of claim 13, wherein the cover plate comprises three wear-washers mounted to an inner surface of the plate.

18. The organizer of claim 13, wherein the cover plate and the backing plate are held together by two or more flathead screws.

19. The organizer of claim 13, comprising one or more over-travel limit features.

20. The organizer of claim 13, comprising a removable and re-positionable device ring.

21. A combination clip and organizer, comprising:
a first plate having a first surface, a second surface, and a first edge;
a retaining clip extending from the first edge and folded onto the first surface and a clip end; and
a second plate, wherein the second plate overlies the second surface of the first plate; and
one or more internally-threaded bosses peripherally arranged toward outer edges of the first plate, and configured to rotatably mount devices

22. An RF blocking apparatus for shielding inserts from radio frequency radiation comprising:
a first plate; and
a second plate overlying the first plate,
wherein the first plate and the second plate comprise a metallized fabric.

23. The RF blocking apparatus claim 30, comprising one or more RFID cards contained between the first plate and the second plate.
